(19) United States
(12) Patent Application Publication
(10) Pub. No.: US 2012/0195570 A1
(43) Pub. Date: Aug. 2, 2012

(54) Broadcast Program Processing Device, Broadcast Program Processing Method and Program Product

(75) Inventors: Takayuki Ishida, Tokyo (JP); Hisashi Tomita, Tokyo (JP); Hirotoshi Maegawa, Tokyo (JP)

(73) Assignee: SONY COMPUTER ENTERTAINMENT INC., Tokyo (JP)

(21) Appl. No.: 13/353,741

(22) Filed: Jan. 19, 2012

(30) Foreign Application Priority Data
Jan. 28, 2011 (JP) 2011-017165

(51) Int. Cl. H04N 9/80

(52) U.S. Cl. 386/239

(57) ABSTRACT

A broadcast program processing device is provided. The device includes a recording unit configured to record content including an advertising video and a recorded data analysis unit configured to obtain an attribute of the advertising video that is included in the recorded content. The device further includes a CM replacing unit configured to obtain an attribute of each of a plurality of advertising videos to be inserted and select one or more of the plurality of advertising videos to be inserted, based on the attribute of the advertising video that is included in the recorded content and the attribute of each of the plurality of advertising videos to be inserted, and a reproduction unit configured to insert the selected one or more of the plurality of advertising videos to be inserted into the recoded content.

### BACKGROUND OF THE INVENTION

1. Field of the Invention

The present invention relates to a broadcast program processing device, a broadcast program processing method and a program product, and in particular, to an addition of an advertising video to content including advertising videos.

2. Description of the Related Art

In many cases, television commercial messages (CMs), or advertising videos, are inserted into broadcast programs, and advertising revenue from these television CMs covers production costs of the broadcast programs. However, in recent years, with the growing popularity of recording/reproduction devices that can easily record large numbers of broadcast programs, there are increasing cases where broadcast programs are not viewed at the time that advertisers expect. In such cases, advertisers may not receive as much advantage of television CMs as they have previously expected. In this regard, Japanese Patent No. 4419324 discloses a video recorder/reproducer capable of replacing a television CM in a recorded program with a television CM that matches viewer's interest.

### SUMMARY OF THE INVENTION

Typically, content of a broadcast program relates to a product or service of television CMs inserted into the program. For example, toy CMs are often inserted into cartoon shows, and grocery CMs are often inserted into cooking shows. This relationship is assumed to effectively motivate viewers to purchase the product or service.

However, according to the device disclosed in the above-noted Japanese Patent No. 4419324, a television CM that matches viewer's interest is newly inserted into the broadcast program regardless of the television CM that has been inserted previously, and thus, there is a possibility that a television CM of the product or service irrelevant to the product or service of the television CM that has been previously inserted into the broadcast program may be newly inserted into the broadcast program. In such a case, the viewer's motivation for purchasing the product or service may not be stimulated effectively.

One or more embodiments of the present invention have been conceived in view of the above, and an object thereof is to provide a broadcast program processing device, a broadcast program processing method, and a program product for effectively motivating viewers to purchase the product or service using television CMs inserted into broadcast programs.

In order to solve the above described problems, a broadcast program processing device according to the embodiment of the present invention includes a recording unit configured to record content including an advertising video, and an obtaining unit configured to obtain an attribute of the advertising video that is included in the recorded content. The broadcast program processing device according to the embodiment of the present invention further includes an obtaining/selecting unit configured to obtain an attribute of each of a plurality of advertising videos for insertion, and select one or more of the plurality of advertising videos for insertion based on the attribute of the advertising video which is included in the recorded content, and the attribute of each of the plurality of advertising videos for insertion. The broadcast program processing device according to the embodiment of the present invention further includes an inserting unit configured to insert the selected one or more of the plurality of advertising videos for insertion into the recorded content.

In addition, the attribute of the advertising video may include information for identifying a product or service to be advertised. Further, the attribute of the advertising video may include information for identifying a category of a product or service to be advertised. Further, the attribute of the advertising video may include information for identifying an advertiser.

The obtaining/selecting unit may select one or more of the plurality of advertising videos for insertion, based on information associated with the recorded content. Further, the obtaining/selecting unit may select one or more of the plurality of advertising videos for insertion, based on a result of an analysis process of the recorded content.

The obtaining/selecting unit may select one or more of the plurality of advertising videos for insertion, based on an attribute of a user. Further, the obtaining/selecting unit may select one or more of the plurality of advertising videos for insertion, based on a time to reproduce the recorded content.

The inserting unit may include means for extending or shortening the selected advertising video for insertion.

Further, a method for processing a broadcast program according to the embodiment of the present invention includes obtaining an attribute of an advertising video included in content that is recorded, obtaining an attribute of each of a plurality of advertising videos for insertion, selecting one or more of the plurality of advertising videos for insertion based on the attribute of the advertising video which is included in the recorded content, and the attribute of each of the plurality of advertising videos for insertion, and inserting the selected one or more of the plurality of advertising videos for insertion into the recorded content.

Further, a program product according to the embodiment of the present invention is a program for causing a computer to execute the steps of obtaining an attribute of an advertising video included in content that is recorded, obtaining an attribute of each of a plurality of advertising videos for insertion, selecting one or more of the plurality of advertising videos for insertion based on the attribute of the advertising video which is included in the recorded content, and the attribute of each of the plurality of advertising videos for insertion, and inserting the selected one or more of the plurality of advertising videos for insertion into the recorded content.

### BRIEF DESCRIPTION OF THE DRAWINGS

In the accompanying drawings:

FIG. 1 is a diagram showing a hardware structure of a broadcast program processing device according to an embodiment of the present invention;

FIG. 2 is a functional block diagram of the broadcast program processing device according to an embodiment of the present invention;

FIG. 3 is a diagram schematically showing partial recorded data;

FIG. 4 is a diagram showing a result of an analysis of recorded data;

FIG. 5 is a diagram showing metadata of replacement CMs; and

FIG. 6 is a flowchart illustrating a reproducing operation of the broadcast program processing device according to an embodiment of the present invention.

### DETAILED DESCRIPTION OF THE INVENTION

An embodiment of the present invention will be described below in detail with reference to the accompanying drawings.

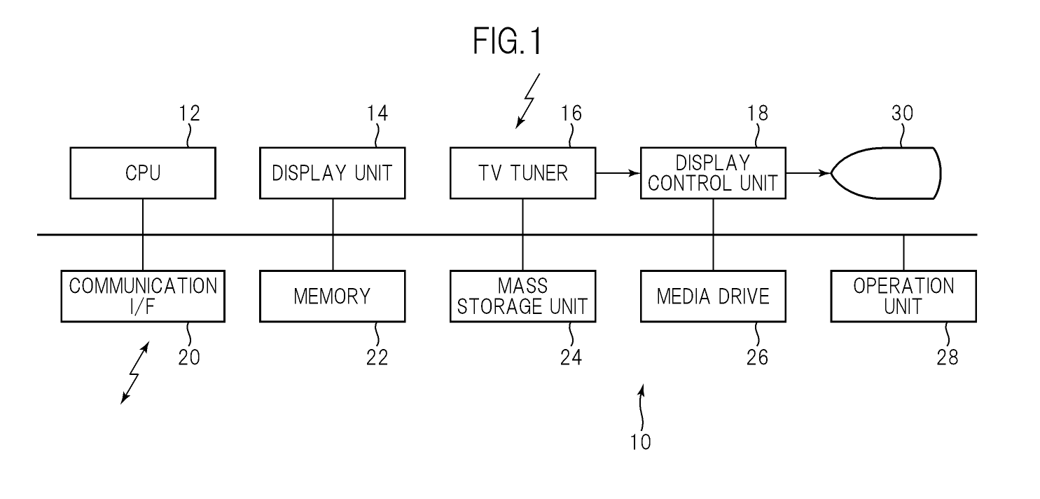

FIG. 1 is a diagram showing a hardware structure of a broadcast program processing device according to an embodiment of the present invention. As shown in FIG. 1, the broadcast program processing device 10 is a computer system mainly configured with a CPU (central processing unit) 12. The CPU 12 controls the entire system in which the CPU 12, a display unit 14, a TV tuner 16, a display control unit 18, a communication interface 20, a memory 22, a mass storage unit 24, a media drive 26, and an operation unit 28 are configured capable of transferring data between each other via a bus.

The display unit 14 includes a display device, such as a liquid crystal display panel, and is arranged at the front of a casing. In response to an instruction from the CPU 12, the display unit 14 displays the current status of the broadcast program processing device, such as a distinction between a state of recording or a state of reproducing, and a channel presently received. A broadcast signal via a ground wave or a satellite wave is fed into the TV tuner 16. Alternatively, a broadcast signal via a wired communication network, such as a cable TV network, is fed into the TV tuner 16. The TV tuner 16 decodes the broadcast signal to generate video data (data showing a moving picture with sound) including a broadcast program with CMs as content. In response to an instruction from the CPU 12, the display control unit 18 outputs to a home television set 30 the video data that is output from the TV tuner 16. Alternatively, the display control unit 18 outputs to a home television set 30 the video data stored in a medium that is received in the media drive 26 or stored in the mass storage unit 24. In this way, the home television set 30 displays on the screen the moving picture shown by the video data, and outputs sound indicated by the video data from an internal or external speaker.

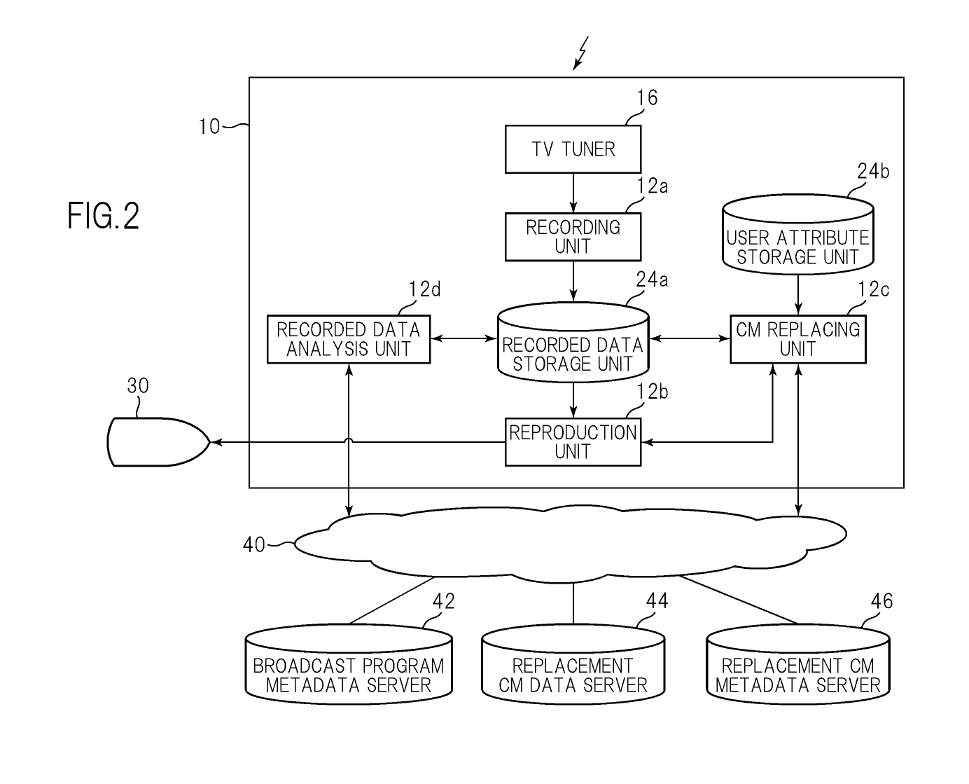

The communication interface 20 is connected to a wide area data communication network 40 (refer to FIG. 2), such as the Internet, and performs data communication with other devices connected to the wide area data communication network 40 in response to an instruction from the CPU 12. The memory 22 includes a volatile and non-volatile semiconductor memory and is used for operation of the CPU 12 or storing a program executed by the CPU 12. The mass storage unit 24 includes a semiconductor memory, such as a flash memory, and a hard disk drive, and stores the video data generated by the TV tuner 16 in response to an instruction from the CPU 12. Further, as described later, an analysis result of the video data stored as mentioned above is also stored in the mass storage unit 24.

The media drive 26 receives portable data storage media, such as a DVD (registered trademark) and a Blu-ray disc (registered trademark), and writes video data thereon or read out video data therefrom. Video data written in the portable data storage media may be video data generated by the TV tuner 16. An analysis result of the video data stored in the portable data storage media as mentioned above is also stored in the mass storage unit 24. The operation unit 28 has a push button and a slide switch, and is arranged at the front of the casing. A user issues an operation instruction to the broadcast program recording device 10 using the push button and the slide switch of the operation unit 28.

As mentioned above, the broadcast program processing device 10 is a computer system mainly configured with the CPU 12, in which a variety of functions are implemented by executing programs stored in the memory 22. FIG. 2 is a functional block diagram of the broadcast program processing device 10. As shown in FIG. 2, the broadcast program processing device 10 functionally includes a recording unit 12a, a recorded data storage unit 24a, a reproduction unit 12b, a CM replacing unit 12c, a user attribute storage unit 24b, and a recorded data analysis unit 12d. Further, as mentioned above, the broadcast program processing device 10 includes the communication interface 20, and can access a broadcast program metadata server 42, a replacement CM data server 44, and a replacement CM metadata server 46, via the wide area data communication network 40.

The recording unit 12a is mainly configured with the CPU 12. When the TV tuner 16 generates video data including a broadcast program with CMs as content, the recording unit 12a stores the generated video data into the recorded data storage unit 24a. The recorded data storage unit 24a is composed of the mass storage unit 24, and may be composed of portable data media received in the media drive 26.

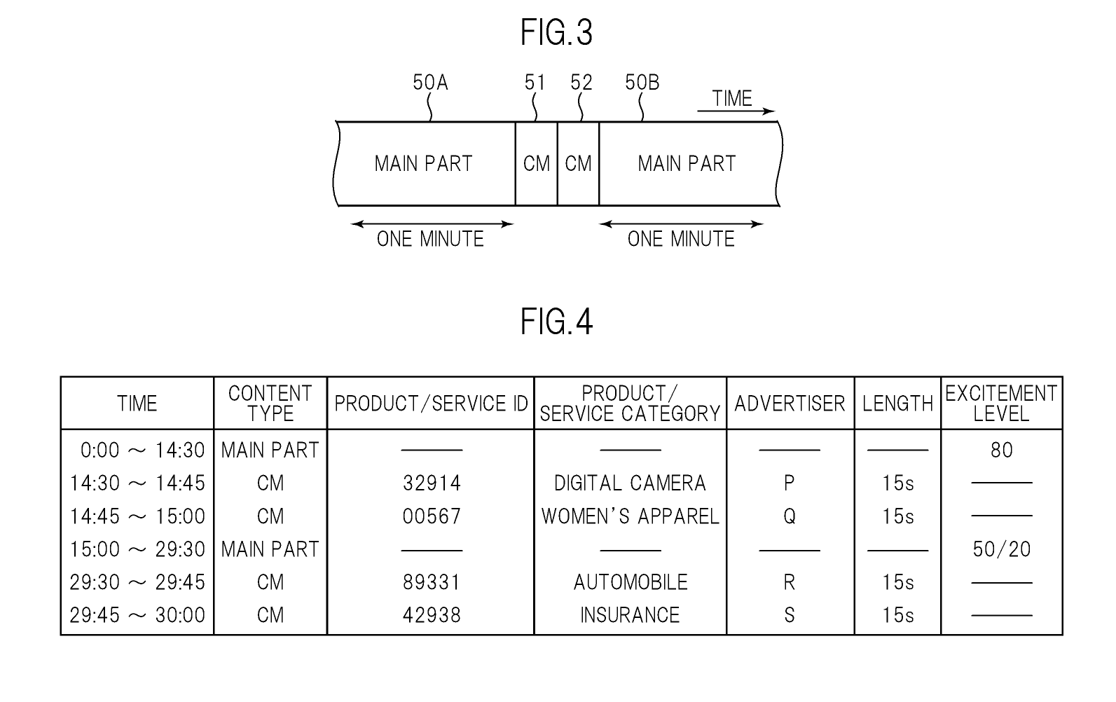

The recorded data analysis unit 12d is mainly configured with the CPU 12. The recorded data analysis unit 12d analyses the video data stored in the recorded data storage unit 24a and stores the analysis result in the recorded data storage unit 24a. Specifically, as shown in FIG. 3, a main part of a broadcast program is divided into parts 50A and 50B, and one or more CMs, here CM 51 and CM 52, are inserted between the parts 50A and 50B. The recorded data analysis unit 12d generates metadata (attribute data) for each part or CM, and stores the generated data into the recorded data storage unit 24a. FIG. 4 shows metadata stored in the recorded data storage unit 24a. As shown in FIG. 4, with respect to each section corresponding to apart or a CM, data indicating a starting time and a finishing time, and distinctions between the main part or the CM, are stored in the recorded data storage unit 24a. In other words, the recorded data analysis unit 12d recognizes a section of each part of the main part and a section of each CM in the video data. For example, when the video data includes data specifying a starting time and a finishing time of each part, a starting time and a finishing time of each CM, and a content type of each section, the recorded data analysis unit 12d stores the starting time and the finishing time of each section, and the distinction between the main part or the CM, into the recorded data storage unit 24a based on such data. Alternatively, when the data specifying a starting time and a finishing time of each part, a starting time and a finishing time of each CM, and a content type of each section are pre-stored in the broadcast program metadata server 42, the recorded data analysis unit 12d receives such data from the broadcast program metadata server 42 and stores the starting time and the finishing time of each section, and the distinction between the main part or the CM, into the recorded data storage unit 24a based on the received data.

Further, the recorded data analysis unit 12d obtains an excitement level of 1 or 2 for each section in which a main part is recorded, and stores obtained excitement level in the recorded data storage unit 24a in association with each section. As shown in FIG. 3, an excitement level is a value indicating a level or degree of excitement of an evaluation section, which is a given section (e.g., one minute) adjacent to a CM section. When a CM section is adjacent to, either before or after, the section in which a main part is recorded, an excitement level 1 is obtained. When CM sections are adjacent to before and after the section in which a main part is recorded, an excitement level 2 is obtained. For example, the recorded data analysis unit 12d may obtain average sound volume of an evaluation section from the recorded data, and generate an excitement level so that greater excitement level is associated with greater average sound volume. Alternatively, when the video data includes data indicating an excitement level of each part, the excitement level may be obtained based on such data. Further, when the broadcast program metadata server 42 stores in advance data indicating excitement level 1 or 2 with respect to each section in which a main part is stored, the recorded data analysis unit 12d may receive such data from the broadcast program metadata server 42.

Further, the recorded data analysis unit 12d obtains information on a product, a product/service ID, a product/service category, an advertiser, and a length of time for each section in which a CM part is recorded. Subsequently, the recorded data analysis unit 12d stores data indicating such information into the recorded data storage unit 24a in association with each section. Here, the product/service ID is information identifying a product or service advertised in the CM. The product/service category is information indicating a category of the product or service advertised in the CM, such as “digital camera”, “cookware”, “insurance”, and “automobile.” Data indicating above mentioned information may be multiplexed to be included in video data. Alternatively, when the data indicating above mentioned information is stored in the broadcast program metadata server 42 in advance, the recorded data analysis unit 12d may receive such data from the broadcast program metadata server 42.

The user attribute storage unit 24b is configured by the mass storage unit 24, and stores attributes of a user of the broadcast program processing device 10, such as gender, age, address, and user group. Here, the user group is information identifying user's preference. Information as mentioned above may be input by a user themselves using the operation unit 28, or may be received from another device connected to the wide area data communication network 40. Further, the user group may be automatically generated by a program in accordance with a history of viewed/recorded broadcast programs.

The CM replacing unit 12c is mainly configured with the CPU 12. Upon receiving an instruction from the reproduction unit 12b, the CM replacing unit 12c selects a CM to be replaced based on the metadata (FIG. 4) which is associated with the video data, and returns the video data of the selected CM to the reproduction unit 12b. Specifically, the CM replacing unit 12c accesses the replacement CM metadata server 46 according to, for example, the predetermined schedule, and receives the metadata of the replacement CM stored in the replacement CM metadata server 46. Subsequently, the CM replacing unit 12c selects a CM to be replaced according to the metadata of received replacement CM, the metadata associated with the video data to be reproduced, and the user attributes stored in the user attribute storage unit 24b.

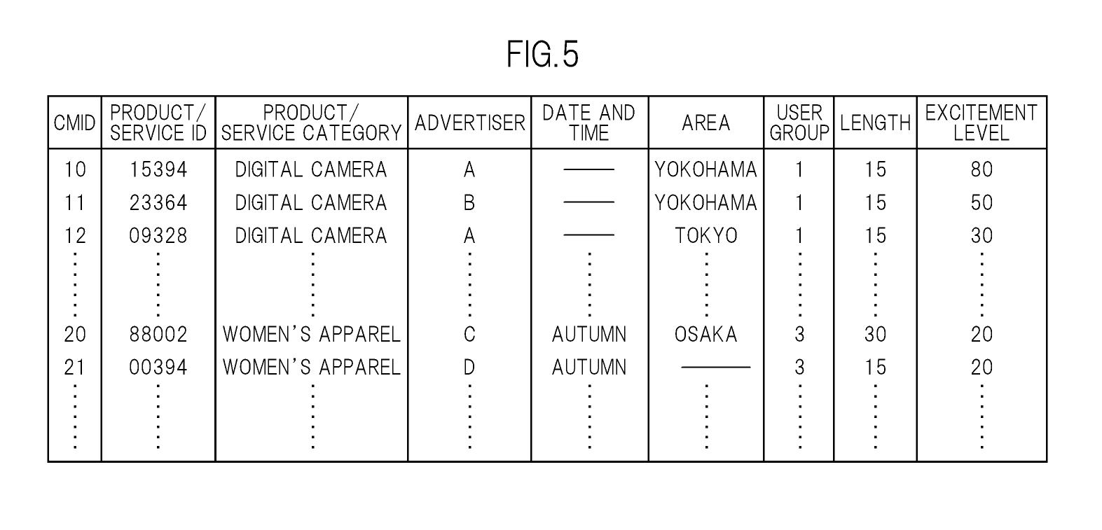

As shown in FIG. 5, the replacement CM metadata server 46 stores an ID, a product/service ID, a product/service category, an advertiser, date and time, an area, a user group, length, and an excitement level for each of large numbers of replacement CMs. Here, date and time suggests a date and time condition for reproducing the video data of the replacement CM. The date and time condition may be information identifying a predetermined time period such as morning, noon, and night, or may be information on a time period including a starting time and a finishing time. Alternatively, the date and time condition may be information identifying a predetermined term such as spring, summer, fall, and winter, or may be information on a term including a starting date and a finishing date, or may be information identifying a day of the week. The area suggests an area where the video data of the replacement CM is to be reproduced. Further, the excitement level is a value indicating a level or degree of excitement of the replacement CM. This value may be set manually, or, similarly to the excitement level of each part of video data, may be calculated on the basis of the average sound volume of the replacement CM.

The CM replacing unit 12c receives video data of the selected CM from the replacement CM data server 44. That is, the replacement CM data server 44 stores video data of large numbers of replacement CMs in association with an ID of each CM. Upon receiving the ID of the selected CM from the CM replacing unit 12c, the replacement CM data server 44 returns the video data of the CM that is specified by the ID.

The CM replacing unit 12c extends or shortens video time if necessary, then provides the video data of each replacement CM to the reproduction unit 12b. In other words, when a length of each CM section stored in the recorded data storage unit 24a does not match a length of the video data received from the replacement CM data server 44, the length of the video data received from the replacement CM data server 44 is extended or shortened so as to be identical to the length of the CM section. For example, when the length of the video data received from the replacement CM data server 44 is shorter, a still picture or a moving picture prepared in advance may be displayed at the beginning or end of the video to make up for the shortfall so that the lengths of reproducing times match each other. On the other hand, when the length of the video data received from the replacement CM data server 44 is longer, the beginning or end parts of the video may be cut off so that the lengths of reproducing times match each other. Alternatively, by using a known technology for extending or shortening video data, a reproducing time of video data may be equally extended or shortened.

When a user issues an instruction using the operation unit 28 to reproduce any video data, the reproduction unit 12b reads out the video data stored in the recorded data storage unit 24a, and converts the video data into a video signal which is output to the home television set 30. At this time, the reproduction unit 12b instructs the CM replacing unit 12c to select a replacement CM, and obtains video data of the selected CM from the CM replacing unit 12c. Subsequently, when the time to reproduce the CM which is contained in the video data stored in the recorded data storage unit 24a arrives, the reproduction unit 12b instead reproduces the video data received from the replacement CM data server 44. When the video data of the replacement CM finishes, video data stored in the recorded data storage unit 24a starts to be reproduced at the point subsequent to the originally inserted CM, in other words, at the point where the subsequent part begins.

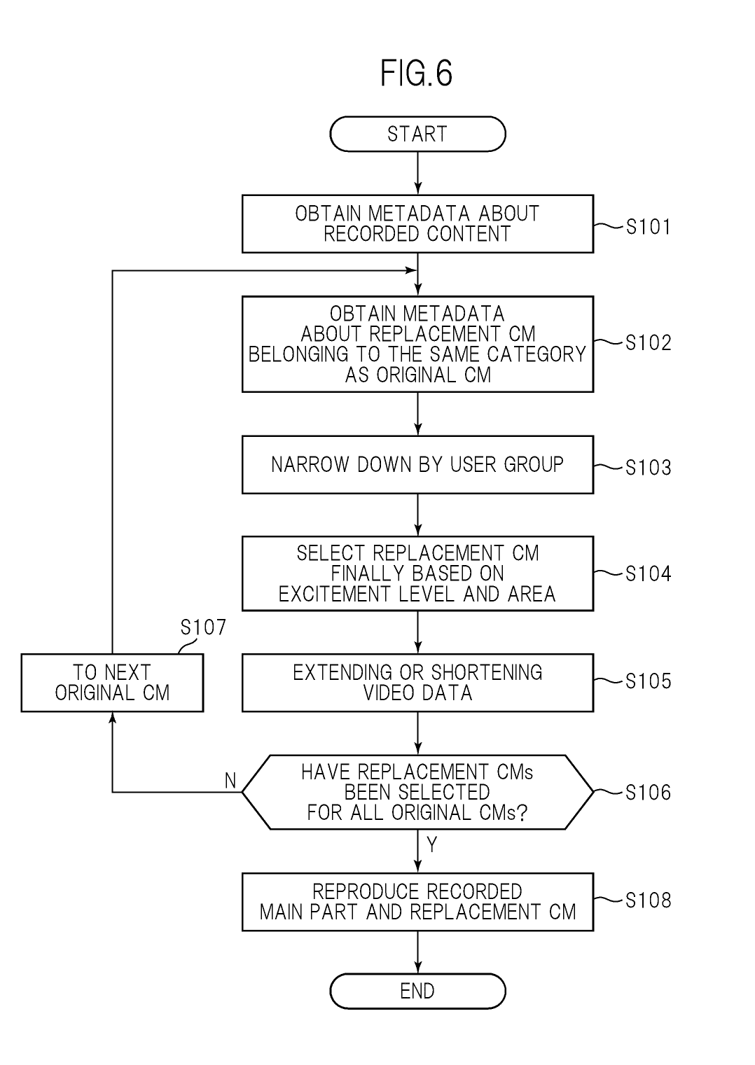

FIG. 6 is a flowchart illustrating the operation of the broadcast program processing device 10 when reproducing video data. The operation shown in FIG. 6 is executed mainly by the reproduction unit 12b and the CM replacing unit 12c when a user issues an instruction using the operation unit 28 to reproduce video data. In this regard, the operation shown in FIG. 6 may be executed after the start of reproducing video data as background processing to video data reproduction.

First, the CM replacing unit 12c accesses the recorded data storage unit 24a in response to an instruction from the reproduction unit 12b, and reads out metadata (FIG. 4) of each section to which the instruction of reproduction has been sent (S101). Next, with respect to one CM section in the video data, the CM replacing unit 12c compares the product/service category associated with the section with the product/service category of each replacement CM received from the replacement CM metadata server 46 so as to select replacement CMs belonging to the same category (S102). Further, the CM replacing unit 12c narrows the replacement CMs selected in S102 by specifying the user group. To be more specific, the CM replacing unit 12c selects replacement CMs associated with the user group that is same as the one stored in the user attribute storage unit 24b (S103).

Further, the CM replacing unit 12c selects one of the replacement CMs narrowed in S103 based on the excitement level and the area, and receives the video data of the selected replacement CM from the replacement CM data server 44. To be more specific, the CM replacing unit 12c calculates, as an evaluation value 1, an absolute value of the difference between the excitement level of each replacement CM and the excitement level of the part that is reproduced at the time closest to the CM to be replaced. Further, the CM replacing unit 12c calculates the distance between the area of each replacement CM and the address of the user as an evaluation value 2, based on the latitude and longitude of the area of each replacement CM and the latitude and longitude corresponding to the address of the user stored in the user attribute storage unit 24b. Subsequently, the CM replacing unit 12c calculates a total evaluation value, which is an increasing function of both of the evaluation value 1 and evaluation value 2, with respect to each replacement CM, so as to select the replacement CM which has the smallest total evaluation value. Here, the increasing function may be, for example, a linear sum of the evaluation value 1 and evaluation value 2. In this way, the replacement CM that has the excitement similar to that of the adjacent part and matches the address of the user is to be selected.

Subsequently, the CM replacing unit 12c obtains the length of the selected replacement CM from the metadata (FIG. 5), and also obtains the length of the CM to be replaced (FIG. 4) from the recorded data storage unit 24a, and compares the former with the latter. The CM replacing unit 12c executes the processing to shorten the video data of the replacement CM when the former is longer, and in contrast, executes the processing to extend the video data when the former is shorter (S105). After the CM replacing unit 12c finishes all processing of S102 to S105 as described above with respect to all CMs contained in the video data to which the instruction of reproduction has been made (S106 and S107), the reproduction unit 12b reproduces in order each part of the main part contained in the video data stored in the recorded data storage unit 24a and each replacement CM obtained in the processing of S102 to S105.

According to the broadcast program processing device 10 as described above, it is possible to insert a television CM that matches viewer's interest while considering the relationship with the television CM originally inserted into the broadcast program, thereby effectively stimulating the viewer's motivation to purchase.

It should be appreciated that the exemplary embodiments as described above are not intended to limit the scope of the present invention in any way, and variations and modifications can be effected within the spirit and scope of the present invention. For example, in the above, a replacement CM is selected so that the product/service category of the replacement CM matches that of the original CM. However, it is possible to select a replacement CM so that the product/service ID of the replacement CM matches that of the original CM. For example, when a CM has a different version as a replacement CM for the same product or service according to the season, it is possible to replace the CM with the different version for the same product or service according to the season. Alternatively, it is possible to select a replacement CM of the same advertiser. This makes it possible to guarantee the advertiser opportunity of advertising. Further, upon receiving the instruction of reproduction, the CM replacing unit 12c may refer to the built-in calendar to obtain the current date and time, and select a replacement CM so that the current date and time may satisfy the date and time condition contained in metadata. In this way, it is possible to select a replacement CM that satisfies the date and time condition relating to, for example, season, time frame, and a day of the week.

Further, some of the functions of the broadcast program processing device 10 shown in FIG. 2, such as the CM replacing unit 12c, the recorded data analysis unit 12d, and the user attribute storage unit 24b, or some of the functions of respective units may be provided on an external device connected to a home network, such as home server, which is located in a home where the broadcast program processing device 10 is placed, or on the server connected to the wide area data communication network 40.

1. A broadcast program processing device comprising:
a recording unit configured to record content including an advertising video;
an obtaining unit configured to obtain an attribute of the advertising video that is included in the recorded content;
an obtaining/selecting unit configured to obtain an attribute of each of a plurality of advertising videos for insertion, and select one or more of the plurality of advertising videos for insertion based on the attribute of the advertising video which is included in the recorded content, and the attribute of each of the plurality of advertising videos for insertion; and
an inserting unit configured to insert the selected one or more of the plurality of advertising videos for insertion into the recorded content.

2. The broadcast program processing device according to claim 1, wherein the attribute of the advertising video includes information for identifying a product or a service to be advertised.

3. The broadcast program processing device according to claim 1, wherein the attribute of the advertising video includes information for identifying a category of a product or a service to be advertised.

4. The broadcast program processing device according to claim 1, wherein the attribute of the advertising video includes information for identifying an advertiser.

5. The broadcast program processing device according to claim 1, wherein the obtaining/selecting unit selects one or more of the plurality of advertising videos for insertion, based on information associated with the recorded content.

6. The broadcast program processing device according to claim 1, wherein the obtaining/selecting unit selects one or more of the plurality of advertising videos for insertion, based on a result of an analysis process of the recorded content.

7. The broadcast program processing device according to claim 1, wherein the obtaining/selecting unit selects one or more of the plurality of advertising videos for insertion, based on an attribute of a user.

8. The broadcast program processing device according to claim 1, wherein the obtaining/selecting unit selects one or more of the plurality of advertising videos for insertion, based on a time to reproduce the recorded content.

9. The broadcast program processing device according to claim 1, wherein the inserting unit comprises means for extending or shortening the selected advertising video for insertion.

10. A method for processing a broadcast program comprising:
obtaining an attribute of an advertising video included in content that is recorded;
obtaining an attribute of each of a plurality of advertising videos for insertion;
selecting one or more of the plurality of advertising videos for insertion based on the attribute of the advertising video which is included in the recorded content, and the attribute of each of the plurality of advertising videos for insertion; and
inserting the selected one or more of the plurality of advertising videos for insertion into the recorded content.

11. A non-transitory, computer-readable storage medium containing a program for causing a computer to execute the steps of:
obtaining an attribute of an advertising video included in content that is recorded;
obtaining an attribute of each of a plurality of advertising videos for insertion;
selecting one or more of the plurality of advertising videos for insertion based on the attribute of the advertising video which is included in the recorded content, and the attribute of each of the plurality of advertising videos for insertion; and
inserting the selected one or more of the plurality of advertising videos for insertion into the recorded content.
